(19) United States
(12) Patent Application Publication
(10) Pub. No.: US 2002/0149587 A1
(43) Pub. Date: Oct. 17, 2002

(54) Method of controlling the display of a character based on a dynamic code generation

(76) Inventor: Dimitri Gorokhovik, Fontainebleau (FR)

Correspondence Address: U.S Philips Corporation, 580 White Plains Road, Tarrytown, NY, 10591, US

(21) Appl. No.: 10/084,721

(22) Filed: Feb. 25, 2002

(30) Foreign Application Priority Data
Feb. 27, 2001 (FR) 0102663

(51) Int. Cl. G06T 11/00

(52) U.S. Cl. 345/467

(57) ABSTRACT

The invention relates to a method intended for controlling the display of at least one character on an output apparatus (DIS), a summary description (DES) of said character being included in a database (DB), said method comprising a step of extracting (RAS) from the summary description of said character (DES) a nonexecutable symbolic code (SYM) defining actions for coloring in points on the output apparatus (DIS), a step of dynamic generation (DYN), from said symbolic code (SYN), of an executable code (BIN), a step of execution (EXE) of the executable code corresponding to said character so as to display the character on the output apparatus (DIS). Advantageously, the method according to the invention comprises a step of storing in a storage module (STO) the executable generated code. Application: Electronic apparatus requiring display as an auxiliary function.

Method of controlling the display of a character based on a dynamic code generation

The invention relates to a method intended for controlling the display of at least one character on an output apparatus, a summary description of said character being included in a database, said method comprising the following steps:

generation of an executable code from the summary description of said character,

execution of the executable code corresponding to said character so as to display the character on the output apparatus.

Such a method is known from the document U.S. Pat. No. 6,005,588. In this document, at least one set of characters, which generally consists of an alphabet and of a certain number of acronyms of a particular size and font, is present inside a database. In this database, the characters are coded according to a character definition language, such as, for example, TrueType or PostScript, thus defining a summary description of the characters. The steps of generating executable code as proposed in the document U.S. Pat. No. 6,005,588 generate, firstly, a bitmap (plane of pixels) for each character of a set of characters. This bitmap is then used by a code generator (a routine) which generates executable code by reading the bitmap line by line.

The possibility of generating the executable code locally from a summary description of the characters allows great portability of fonts. For example, the summary description of the characters in a certain font and for a certain size required for the display of a web page can be sent over the Internet at the same time as this page. The reconstruction of the texts is done locally by code generation.

The invention is related to the following considerations:

In the document U.S. Pat. No. 6,005,588, the generation of the code is done by virtue of a routine which reads the bitmaps, said routine being the same irrespective of the bitmap read. Consequently, since this routine works on bitmaps, it necessarily reads all the lines of the pixel plane. The code obtained is compiled in advance. In the preferred embodiments of the document U.S. Pat. No. 6,005,588, this compilation is completed in the course of code simplification steps. The generated code is essentially composed of calls to functions (“DrawPixel”; DrawLine”). Actually, generation from bitmaps does not allow a more thorough optimization of the generated code. During execution, the calling of the functions gives rise to some loss of time.

An object of the invention is to allow the simplified generation of a code while remaining at a high level of abstraction, the executable code obtained having very fast execution.

Actually, a method intended for controlling the display of at least one character on an output apparatus, in accordance with the introductory paragraph is characterized according to the invention in that the step of generating the executable code comprises two substeps:

a step of extracting, from the summary description of said character, a nonexecutable symbolic code defining actions for coloring in points on the output apparatus,

a step of dynamic generation, from said symbolic code, of the executable code.

The symbolic code is necessary for the implementation of the dynamic generation. However, these two steps may be divorced to a greater or lesser extent. The hardware currently available makes it possible to undertake the dynamic generation of code with good reliability and good speed. This reliability and this speed are improved regularly by advances in techniques. The duration required for the dynamic generation of code can be more substantial than, for example, the generation of a bitmap from the same data but in all cases, the speed of execution of the dynamically generated code compensates for this handicap when the character is repeated.

In an advantageous embodiment, the method is such that the executable generated code is stored in a storage module. When the display of a character is required, it is then sufficient to call up the execution of the executable code already generated and stored in the memory: the time corresponding to successive generations of the executable code is then saved.

Document U.S. Pat. No. 6,005,588 thus proposes that the executable code be stored. However, the document U.S. Pat. No. 6,005,588 proposes that executable code be generated, in a prior step, for an entire set of characters in all the fonts which will be used, said fonts consequently being known in advance. Cited document thereafter proposes that this code be stored, and then that the codes corresponding to the characters required for the display be used as needed. This entails the generation of executable code for unused characters and consequently loss of time.

In a preferred embodiment of the invention, the method according to the invention comprises the following steps:

reception of a request to display said character,

search for an executable code corresponding to said character in the storage module,

decision, depending on the result of the search, to:

when the executable code corresponding to said character is absent from the storage module, generate this code from the summary description of said character, store it in the storage module and execute it so as to display said character on the output apparatus,

when the executable code corresponding to said character is present in the storage module, execute it so as to display said character on the output apparatus.

Actually, the dynamic generation of code according to the invention can be easily performed simultaneously with the execution of the display, that is to say in real time and not in a prior step. The characteristics of a generation of executable code according to the invention thus allow the executable code corresponding to said character to be generated when the executable code corresponding to said character is absent from the storage apparatus.

Advantageously, the storage apparatus is a cache memory allowing dynamic management of the storage of the generated codes. This preferred embodiment allows maximum exploitation, in terms of duration of processing of the display, of the generation of code according to the invention: on the one hand, the generation step being fairly lengthy, the code is generated only when needed and on the other hand, the code already generated, very fast in execution, is recalled directly so as to be executed.

An application of the invention relates to a computer program product containing code for carrying out the steps of the method according to the invention. The invention can be deployed in any device intended for displaying at least one character on an output apparatus.

In one of its applications, the invention can be advantageously implemented in any electronic apparatus requiring a display of characters which can be of various sizes and of various fonts on an output apparatus: telephone, mobile phone, electronic apparatus linked with a network, for example Internet: computer, fax, printers etc. The invention is particularly beneficial in respect of apparatus containing one or more processors with no hardware medium dedicated to the manipulation of pixel planes.

The invention will be better understood in the light of the following description of a few embodiments, given by way of example and with regard to the appended drawings, in which:

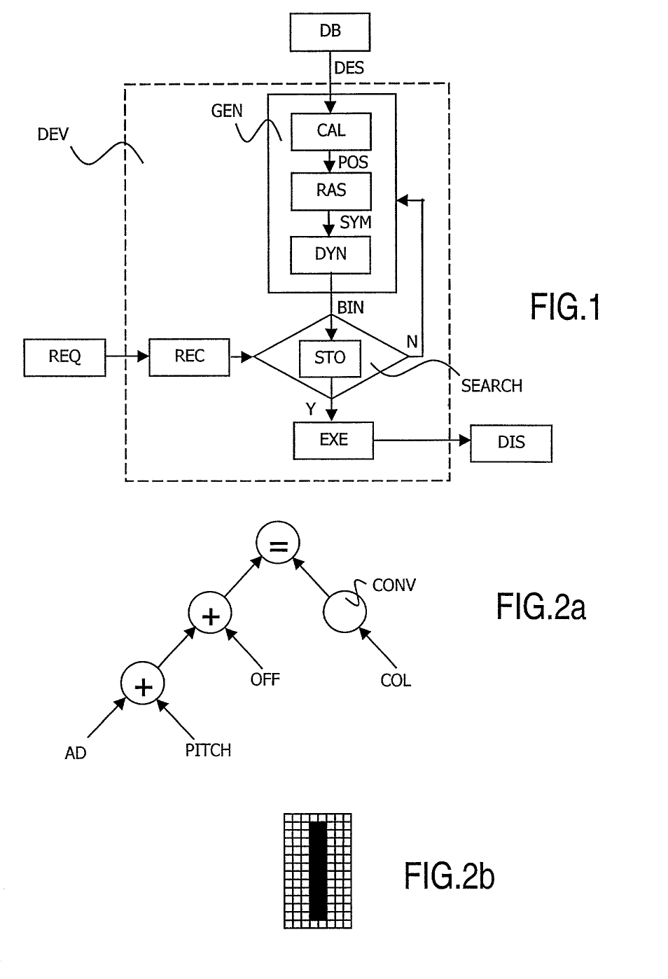

FIG. 1 is a functional diagram representing the various steps of a method intended for displaying at least one character on an output apparatus, according to the invention.

FIG. 2a illustrates a symbolic representation attached to the display of the letter I represented in FIG. 2b.

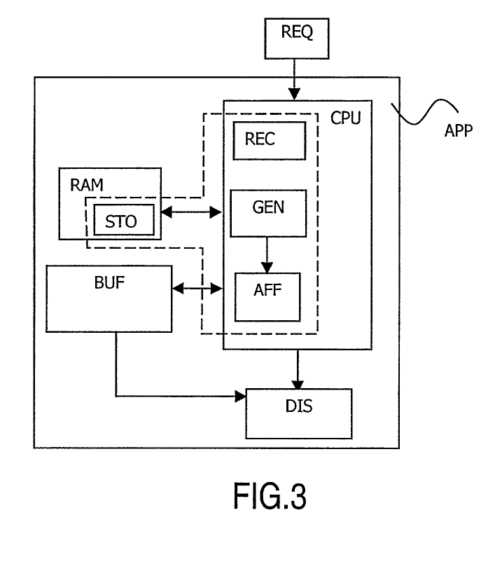

FIG. 3 is a schematic diagram of an electronic apparatus according to the invention.

FIG. 1 is a functional diagram representing the various steps of a method intended for controlling the display of at least one character on an output apparatus DIS. FIG. 1 represents a preferred embodiment of the invention. In this preferred embodiment, the method according to the invention comprises a step of reception carried out in means of reception REC of a request REQ to display said character. A step SEARCH of searching for an executable code corresponding to said character is then performed in a storage module STO. When an executable code corresponding to said character is found in STO (case “Y”), the address of said code is sent to an execution module EXE where said code is executed so as to display said character on the output apparatus DIS external to a device DEV implementing the method, described above, according to the invention. When no executable code corresponding to the character is found in the storage module STO (case “N”), a step of generation GEN of executable code BIN is activated. The storage module STO thus exhibits the manner of operation of a cache memory which can, in an advantageous implementation, be a part of a RAM memory dedicated completely to the storage of this type of graphical data. In effect, the method according to the invention has the advantage of producing code to be stored, said code being storable in conventional inexpensive memories, this not being the case for the bitmaps for which an expensive graphics memory is generally required. The cache memory manner of operation described here is specific to the preferred embodiment of the invention and allows maximum exploitation, in terms of duration of processing of the display, of the generation of code according to the invention: on the one hand, the generation step being fairly lengthy, the code is generated only when needed and, on the other hand, the code already generated, very fast in execution, is recalled directly so as to be executed. This embodiment does not, however, exclude other implementations of storage.

Generating and storing code instead of bitmaps allows faster display by direct reading of the executable code stored instead of the conventional procedures for displaying characters consisting in calling, for each character, the corresponding bitmap stored and to have it read, in order to display the character, by a routine (execution of a binary code) common to all the bitmaps, said routine generating the executable code. Thus, the benefit of storing the executable code exists principally, nowadays, with regard to apparatus for which the installation of a system dedicated to the manipulation of graphical data (bitmaps etc), such as for example, a dedicated graphics chip, is not recommended for reasons of cost, efficiency, energy consumption or other constraints.

The step of generation GEN of executable code BIN is in conjunction with a database DB including at least one summary description DES of said character. The summary description DES may be of very low level, for example a description in terms of real numbers of curves making it possible to describe the characters (Besier curves for letters for example), or of a higher level for example PostScript or TrueType, generally representing curves in a language specific to these formats. These summary descriptions DES give a drawing of the character. The aim of the invention is to provide a structure for interpreting these drawings.

In the conventional systems using bitmaps, a system of coordinates is attached to an empty bitmap of maximum size for the font and the size specified. For example, the origin of the coordinate system is the top left corner. This configuration is commonplace but any other solution is possible (bottom left corner etc). In this coordinate system, the points described in the summary description (for example the Besier points) are placed in respect of the character of the size and of the font required. The corresponding curves are then plotted based on the positioned points. The interior of the contours formed by these curves are blackened by blackening each pixel of the bitmap which lies inside this contour. The process for going from the coordinate space to the pixel space is called “rasterization”. This system requires the subsequent processing of the bitmaps. In the state of the art, this processing is carried out by a routine which reads all the lines of the bitmap. The reading of all the lines of the bitmaps demands time. This approach is not well suited to apparatus not comprising a system dedicated to the manipulation of pixel planes which are of special interest to the invention. Moreover,the code obtained is not optimal since it comprises function calls which impair the speed of execution of said code. The invention proposes a different approach. This approach comprises a step similar to the first step of the conventional approach: a step of calculating CAL the positions POS of the points and of the curves defining the characters in a coordinate system similar to that described above, from the summary description DES. Each line is then passed as a system of pixels into a step of “rasterization” RAS in this coordinate system but instead of producing black points, this step extracts, from the positions POS, symbolic code SYM which it would be necessary to execute so as precisely to color in the points. This step defines, in fact, actions for “coloring in” bytes coding in respect of points on the output apparatus. The symbolic code is not, however, a directly executable code. A generation step DYN then generates code dynamically from the SYM code, exclusively dedicated to this task. The generator DYN of the executable code imposes the exact format of the symbolic form. The two steps RAS and DYN can be separated or intermingled. Said two steps may thus be indivisible: extraction of the symbolic code for a line of pixels—generation of the corresponding executable code—extraction of the symbolic code for the following line—etc. Doing things this way may be especially advantageous when there is not enough available memory to temporarily store the symbolic form SYM. Everything depends on the generator DYN used and on the embodiment chosen. The executable code thus obtained does not contain any function calls but consists of “colored” bytes. By the very nature of dynamic generation, the body of a “drawpixel” routine such as presented in the state of the art is in fact automatically “inserted” into the code as many times as necessary. Seeing that any function call is eliminated from the code generated according to the invention, it is inappropriate to envisage a simplification of the lines as set forth in the document of the prior art by calling a “DrawLine” function instead of ten calls to a “DrawPixel” function. Steps which are expensive in terms of computation time and resources are thus eliminated from the display control method according to the invention. The “custom-made” nature of the generation of the executable code according to the invention is indeed counter to the generation of this code by reading of a bitmap by a similar routine for all the pixels. The generation according to the invention makes it possible to remain at a high level of abstraction and, in certain configurations, to gain computation time. It is made possible through the advances in techniques concerning the dynamic generation of code. The generated executable code executes very fast. Once generated, the executable code is executed in a step EXE so as to display the character on the output apparatus. An additional advantage of the generation of executable code according to the invention is that it can be easily performed simultaneously with the execution of the display, that is to say in real time. This makes it possible to envisage the preferred embodiment presented above, in which the code generation is done when needed.

In an advantageous implementation, a kind of table included in the storage apparatus STO presents, on the one hand, the parameters fixed when executable codes are generated and, on the other hand, correspondingly, the address of the executable codes corresponding to these parameters. This table is read during the step SEARCH of searching for the executable code corresponding to the character to be displayed. By calling its address, the executable code BIN is, for example, reproduced directly in the string of display instructions. The generated routine can thus use instructions for filling memory blocks, available on certain CPUs, it can also use the DMA controller with the same aim (DMA standing for Direct Memory Access). This could not be envisaged in the case of the generated code in document U.S. Pat. No. 6,005,588 on account of the very structure of this code.

An example of the symbolic form SYM is shown diagrammatically in FIG. 2a. This Figure is merely indicative of a special embodiment. The symbolic code has, in this example, a so-called “treelike” structure. In this Figure, the structure of a symbolic code SYM intended for drawing an “I” in the “sans serif” font such as Arial within a frame of size 14×8 with the color COL is represented. To draw this letter it is necessary to blacken columns 3 and 4, counting from 0 in lines 1 to 12 counting from 0, as is represented in FIG. 2b.

This symbolic code receives the following arguments:

the address AD of the origin point (0;0) (top left corner of the letter);

the color COL in which the letter is plotted;

the size PITCH of the line of the graphical scene in which the letter is to be drawn, as a number of bytes;

The following parameters are, in essence, fixed in the symbolic code:

type of the font (Arial);

size of the font (14);

case of the letter (uppercase);

style of the font (normal);

number of bits per pixel (8, that is to say one byte per pixel, in general).

In FIG. 2a is thus represented the symbolic code for coloring in the point (1;3) forming part of the uppercase letter I in the Arial font with the desired size. This treelike symbolic code forms part of a routine defined on the basis of the variables and fixed parameters: routine_I₁₃ uppercase_arial_{—}14_normal (AD,COL,PITCH).

The starting address AD is an input of the tree as well as the color COL and the size PITCH of the graphical line. To color in the point (1;3), it is firstly necessary to “skip” a line (PITCH from AD) then to make an offset OFF of 3 points so as to reach the point (1;3) and then to color in the corresponding byte with the color COL.

The remaining points are colored in the same way: the expression is repeated for the other values of addresses corresponding to the points to be colored in. However, the address only needs to be calculated completely once, so as subsequently to be incremented by 1 on going to another point of the same line, and by PITCH on going to the next line. In the particular implementation represented in FIG. 2, the color COL is converted in 8 bits in a step CONV. Specifically, the interface of the routines must be the same irrespective of the resolution of the graphical scene: 4, 8 or 16 bits. Thus, the passed color is defined in 32 bits, each routine taking its own specific part. Consequently, all these optimizations are performed when extracting the symbolic code and when generating the executable code, and not when executing the latter. The symbolic code can be represented in a memory as a set of treelike structures as described above or else as a code sequence for a stack-type machine, that is to say by a sequence of “byte codes” stored in an array of bytes:

Load address

Load pitch

Add

Load 3

Add

Load color

Storebyte

Another possibility is to represent this code in a memory array by triplets of the format <<t1<-operation (t2,t3)>>:

Add %r1,address,pitch

Add %r1,%r1,3

MoveByte [%r1],color

The methods of internal representation of the executable code in memory are well known from the field of the compilation of programming languages where they also serve to perform optimizations on a code. It is very often called “the internal representation” of the code. “Compilers: Principles, Techniques and Tools” by Aho A. V., Sethi R., and Ullman J. D. (Addison Wesley, Reading, Mass., 1986, ISBN 0201100886) chap-8,9 is an exemplary reference for the description of symbolic forms also called intermediate code. The symbolic code may possibly be stored. This is, for example, advantageous if the time to generate it from PostScript is long and if its size is negligible relative to the size of its executable code. In this case, if the decision is taken to eliminate from the cache the executable generated code corresponding to a character, the symbolic code stored in memory will be used, at the next request to display the character, for the generation of the executable code instead of reprocessing the PostScript again. However, if the size of the symbolic code is comparable with that of the executable code, it is better for the executable generated code corresponding to a character to never be deleted from the cache, rather than storing both, thus duplicating the memory required. The choice of the format of the symbolic code is imposed by the generator DYN of executable code which will be used to produce the executable code BIN from the symbolic code SYM. Dynamic generators of executable binary code are known from the state of the art, for example, in the document: “Finite-State Code Generation” by C. W. Fraser and T. A. Proebsting in ‘Microsoft Research, One Microsoft Way’, Redmond, Wash. 98052 and “VCODE: A Retargetable, Extensible Very Fast Dynamic Code Generation System” by D. R. Engler in ‘Proceedings of the 23rd Annual ACM Conference on Programming Language Design and Implementation’, May 1996, Philadelphia Pa. These code generators transform the symbolic code SYM into executable code, this executable code BIN is directly binary and is that which is stored.

FIG. 3 is a diagrammatic layout of an electronic apparatus APP requiring a displaying of at least one character on an output apparatus DIS. This electronic apparatus APP comprises a processor CPU, a memory RAM including a storage module STO according to the invention, a graphics memory BUF dedicated to graphical display and an output apparatus DIS. This electronic apparatus APP is furthermore equipped with a system REC for receiving a display request REQ. This display request is for example generated by keypad input or by the reception of data transported by a network or by waves. Represented as being external to the apparatus APP, the request can also be generated internally. Electronic apparatus is, furthermore, linked with a database including summary descriptions of characters. This database, which is not represented here, can be included locally in the electronic apparatus APP or can be received by this electronic apparatus APP, for example, at the same time as the display request REQ (web page etc). A display device DEV according to the invention is included in the electronic apparatus APP according to the invention, this display system DEV is, in FIG. 3, surrounded by dashes; it comprises in particular an execution module EXE and a module GEN for generating executable code constructed according to the principle of the generation step depicted in FIG. 1 by means of extraction, from the summary description of said character, of a nonexecutable symbolic code defining actions for coloring in points on the output apparatus and means of dynamic generation, from said symbolic code, of the executable code. The electronic apparatus APP, represented diagrammatically in FIG. 3, can, in practice, be a portable GSM telephone which can access the Internet, a computer receiving web pages with fonts defined in the pages, as well as any other electronic apparatus comprising a display unit and a microprocessor which has to display text by using dynamically loaded fonts for which the graphical display is not the prime function and for which the use of sophisticated graphics hardware is not justified.

Although this invention has been described in accordance with the embodiments presented, a person skilled in the art will immediately recognize that there are variants to the embodiments presented and that these variants are within the spirit of the present invention. Thus, modifications may be made by a person skilled in the art without, however, departing from the scope of the invention defined by the following claims.

1. A method intended for controlling the display of at least one character on an output apparatus, a summary description of said character being included in a database, said method comprising the following steps:
generation of an executable code from the summary description of said character,
execution of the executable code corresponding to said character so as to display the character on the output apparatus, characterized in that the step of generating the executable code comprises two substeps:
a step of extracting, from the summary description of said character, a nonexecutable symbolic code defining actions for coloring in points on the output apparatus,
a step of dynamic generation, from said symbolic code, of the executable code.

2. A method as claimed in claim 1, characterized in that the executable generated code is stored in a storage module.

3. The method as claimed in claim 2, which method comprises the following steps:
reception of a request to display said character,
search for an executable code corresponding to said character in the storage module,
decision, depending on the result of the search, to:
when the executable code corresponding to said character is absent from the storage module, generate this code from the summary description of said character, store it in the storage module and execute it so as to display said character on the output apparatus,
when the executable code corresponding to said character is present in the storage module, execute it so as to display said character on the output apparatus.

4. A device intended for controlling the display of at least one character on an output apparatus, a summary description of said character being included in a database accessible to the device, including:
a generation module related to the database and intended to generate an executable code from the summary description of said character,
an execution module, coupled to the storage apparatus and to the output apparatus, said execution module being intended to execute the executable code corresponding to said character so as to display said character on the output apparatus, characterized in that the generation module includes:
means of extracting, from the summary description of said character, a nonexecutable symbolic code defining actions for coloring in points on the output apparatus,
means of dynamic generation, from said symbolic code, of the executable code.

5. A device as claimed in claim 4, which device comprises a storage module coupled to the generation module and intended to store the generated executable code.

6. A device as claimed in claim 5, which device comprises:
means of reception of a request to display said character,
means of searching for an executable code corresponding to said character in the storage module,
means of decision, depending on the result of the search for the executable code corresponding to said character, for:
when the executable code corresponding to said character is absent from the storage module, generating this code from the summary description of said character, storing it in the storage module and executing it so as to display said character on the output apparatus,
when the executable code corresponding to said character is present in the storage module, executing it so as to display said character on the output apparatus.

7. An electronic apparatus comprising at least:
means of access to a database containing summary descriptions of characters,
a device intended for controlling the display of at least one character on an output apparatus as claimed in one of claims 4 to 6, said database being accessible to said device,
an output apparatus intended to display at least one character and controlled by the control device.

8. A computer program product for controlling the display of at least one character on an output apparatus intended to display, a summary description of said character being included in a database accessible to the computer, comprising at least the instructions necessary for carrying out the steps of the methods described in one of claims 1 to 3.
